(19) United States
(12) Patent Application Publication
(10) Pub. No.: US 2005/0150476 A1
(43) Pub. Date: Jul. 14, 2005

(54) Combination of cylinder liners consisting of a light metal alloy

(76) Inventors: Uwe Gohrbandt, Haan (DE); Peter Krug, Velbert (DE); Jurgen Baumgarten, Wuppertal (DE)

Correspondence Address: KATTEN MUCHIN ROSENMAN LLP, 575 MADISON AVENUE, NEW YORK, NY, 10022-2585, US

(21) Appl. No.: 11/051,549

(22) Filed: Feb. 4, 2005

Related U.S. Application Data
(63) Continuation of application No. PCT/EP03/08287, filed on Jul. 28, 2003.

(30) Foreign Application Priority Data
Aug. 6, 2002 (DE) 102 359 10.5

(51) Int. Cl. F02F 1/00

(52) U.S. Cl. 123/193.2

(57) ABSTRACT

The invention relates to a combination of individually pre-fabricated cylinder linings consisting of a light metal alloy with inlaid hard phases for casting into a cylinder block of an internal combustion engine. In said combination, a plurality of cylinder linings (2,3,4) are joined in a row by means of a non-positive and/or positive engagement, the distance between the axes of the cylinder linings corresponding to the cylinder bore center distance of the cylinder block.

The present invention pertains to the field of the engineering of automotive engines and relates in particular to cylinder liners which are to be cast into the cylinder block or crankcase of a reciprocating-piston internal combustion engine.

Nowadays, the cylinder blocks or crankcases of internal combustion engines are generally made from alloyed aluminum in order to reduce weight. However, inexpensive aluminum alloys with good casting and working properties are subject to the drawback of a relatively low hot strength and a poor resistance to wear at the piston running surfaces of the cylinder bores. Consequently, running surfaces of this type are unsuitable for use as direct running partners for the pistons with piston rings.

To increase the wear resistance of the piston running surfaces, it is known to provide cylinder liners which are made, for example, from a hypereutectic aluminum-silicon alloy.

The problem in this case is that of fixing the cylinder liners in the cylinder block or crankcase such that they cannot slide or rotate. For this purpose, the liners are either retrospectively fitted into the completely machined cylinder block, in particular by pressing or thermal joining, or the aluminum alloy is cast around the liners during casting of the cylinder block; in this context, the casting-in of the cylinder liners can be regarded as the preferred production process.

When casting in the cylinder liners, the liners have hitherto been placed individually into the casting mold for the crankcase, for example by being fitted onto conical centring sleeves, and then the aluminum alloy has been cast around them. However, unless special precautions are taken, this process also entails technical problems which result in particular from the need to maintain a minimum web width between the liners during casting. For example, in the case of the pressure die-casting process which is customarily used, it is necessary to maintain a distance of at least a few millimeters (generally 2-3 mm) between the liners, to ensure sufficient filling of the space between the liners with melt and to ensure that the liners are fixed in the cylinder block such that they cannot slide or rotate after the melt has cooled. This is particularly true of the slow-filling casting processes, such as gravity die-casting and sandcasting, which are less frequently used for this purpose and in which even significantly greater distances have to be maintained between the liners to ensure that the liners are completely cast in.

When producing internal combustion engines, the center-to-center distance of the cylinder bores is a central parameter in the design of the engine, and changing this parameter would entail far-reaching design changes. To avoid these difficulties, in practice the center-to-center distance of the cylinder bores is regarded as a quasi-constant parameter. The same restrictions apply to the overall length of the cylinder block and therefore also to the maximum length of the liners which are cast into it, predetermining the maximum possible piston stroke. This means that on account of the minimum distance between the liners which is required for casting reasons and limits the diameter of the cylinder spaces, disadvantageous restrictions are imposed on the maximum displacement which can be achieved for a given design of engine.

Furthermore, it has been found that if the distance between the liners which have been cast into the cylinder block is small, the strength of the web region between the liners decreases. This is particularly true with regard to the torsional rigidity of the cylinder crankcase, which as is known has to withstand high torsional loads when the internal combustion engine is operating. In particular when the internal combustion engine is running at high speeds, there is a risk of cracks or fractures occurring in the web region between the cylinder liners, which in the most serious circumstances can cause loosening of the liners and resultant failure of the engine.

A further point which should be noted that in modern internal combustion engines the cylinder head gasket located between cylinder head and cylinder block is subject to ever increasing loads on account of ever higher temperatures and pressures in the combustion chamber. To avoid leaks, therefore, the cylinder head has to be pressed (“prestressed”) onto the cylinder block under a sufficiently high force, but in this context it should be noted that an excessively high compressive force can lead to undesirable changes in shape at the cylinder head or cylinder block. In particular a high compressive force of the cylinder head promotes plastic deformation of material beneath the cylinder head gasket (“compression creep”). This effect occurs in particular in the region of the webs beneath the beads of the cylinder head gasket, which are disadvantageous in this respect, with the result that leaks may occur in particular where the cylinder bore center-to-center distances are short.

Furthermore, the conventional processes used to cast the liners into the cylinder block often also present the problem whereby the liners which have been fitted onto the centring sleeves cannot be fixed in place sufficiently securely and therefore move during the casting-in process, which in practice has proven a common reason for the production of scrap.

DE 696 11 751 T2 describes a process for producing cylinder blocks in which a liner arrangement comprising liners which are joined by an elastic silicone adhesive, is cast into a casing block. In the liner arrangement, cylinder liners can move relative to one another in a direction in which the cylinder liners are oriented.

DE 693 04 718 T2 and DE 692 18 395 T2 describe a monolithically cast cylinder liner arrangement comprising cylinder liners.

It is an object of the present invention is to overcome the drawbacks of the processes known from the prior art for casting cylinder liners into a cylinder block as have been outlined in the introduction.

For this purpose, the invention provides a combination of individual prefabricated cylinder liners made from a light metal alloy with included hard phases for casting into a cylinder block of an internal combustion engine, in which a plurality of cylinder liners arranged in line, with the center-to-center distance of the cylinder liners corresponding to the center-to-center distance of the cylinder bores in the cylinder block, are joined in a force-fitting and/or form-fitting manner. Therefore, the cylinder liners are joined in such a manner that the arrangement of their cavities corresponds to the arrangement of the cylinder spaces of the cylinder block, which may still require further processing.

Since the cylinder liners have already been joined, and therefore it is no longer necessary for any melt to flow into the space between the cylinder liners during casting of the cylinder block or crankcase around the liners, the distance between the cylinder liners, which are to be cast in as liners, can advantageously be selected to be less than the distance needed when casting in individual liners in the conventional way. The cylinder liners can be joined and cast into a cylinder block at a distance from one another, i.e. with a spacer between them, without a distance between one another, i.e. with their outer circumferential surfaces in contact with one another, or even with a reduced center-to-center distance, i.e. with a reduction in the thickness of the cylinder liner walls. In particular when using a predetermined center-to-center distance for the cylinder bores, this allows the internal diameter of the liners to be increased compared to the prior art, so as to produce a greater cylinder displacement. Advantageously, therefore, greater displacements and therefore higher powers of the internal combustion engine can be achieved for the same stroke length and the same center-to-center distance of the cylinder bores.

Even with very short or negligible distances between the liners, it is always ensured that the cylinder liners are fixed such that they cannot rotate or slide in the cylinder liner combination according to the invention, since the liners are already reliably joined together when they are being cast in, irrespective of the casting technology restrictions imposed in the prior art. Unlike in the prior art, where there is a risk of individual liners coming loose in particular with very small web widths between the liners and at high speeds of the internal combustion engines, given sufficiently secure joining of the cylinder liners, (which is always possible), there is no risk of individual liners becoming detached from the joined combination when the internal combustion engine is operating. Furthermore, the rigid combination of the cylinder liners significantly improves the torsional rigidity of the cylinder block.

A further advantage when casting in-the cylinder liner combination is that unlike in the prior art, where each liner has to be positioned and fixed individually, the combination merely needs to be positioned and fixed as a single unit. Since it is not possible for individual cylinder liners in the combination to move when the combination is being cast into the cylinder block or crankcase, the relative position of the liners which are to be cast in is always identical. The positioning and fixing of the overall combination, which is all that is still required, is fundamentally simpler, more reliable and in particular also faster to implement than in the case of individual liners as, in the prior art. This makes an advantageous contribution to reducing the scrap rate during production of the cylinder blocks and to accelerating the process on account of the time gained.

The cylinder liners are preferably joined by the application of joining seams by means of a conventional welding process. By way of example, the laser beam, electron beam or friction twist welding process can be used for this purpose. On the other hand, it is generally also possible for the cylinder liners to be joined exclusively or additionally by means of a positively locking connection. By way of example, the cylinder liners can be joined in the style of a dovetail joint along the profiled-section axes, so that the cylinder liners are secured in a direction perpendicular to the profiled-section axes.

In an advantageous configuration of the combination of cylinder liners according to the invention, the cylinder liners have abutting surfaces which are suitable for joining on their outer circumferential surfaces. These abutting surfaces may, for example, be flattened parts which are brought to bear against one another when the combination is being joined. Flattened parts have the particular advantage that the cylinder liners can be joined even more closely together, and therefore, for a given center-to-center distance of the cylinder bores and a given longitudinal stroke, and taking account-of a minimum wall thickness required for the cylinder liners, it is possible to increase the cross-sectional area of the cylinder liner and therefore the displacement of the liner still further.

As has already been outlined in the introduction, the cylinder liners can be joined with or without a distance between adjacent cylinder liners or even with a reduction in this distance, so that it is always ensured that the distance between the hollow cylinder axes corresponds to a predetermined center-to-center distance of the cylinder bores of the cast-in liners.

In modem internal combustion engines, the cylinder head gasket is exposed to ever greater loads on account of high temperatures and pressures in the combustion chamber, and consequently the cylinder head has to be pressed onto the cylinder block with a very high compressive force. To avoid the associated disadvantageous consequences (e.g. compressive creep), it is advantageous if cooling between the liners ensures that that flow limits of the material are not reached and therefore plastic deformation can be avoided.

For this purpose, in the combination according to the invention at least one passage which is open on one or both sides and is suitable for transporting cooling fluid may advantageously be formed in the joining region between adjacent cylinder liners. Cooling of the joining region, for which purpose cooling fluid is pumped through the passage which is open on one or both sides, advantageously makes it possible to avoid plastic deformation of material as a result of high prestressing of the cylinder head.

A passage of this type may be configured in such a way that it is recessed in at least one of the outer circumferential surfaces of the adjacent cylinder liners within the joining region. For example, the passage may be formed either by a recess in just one outer circumferential surface or by recesses in both outer circumferential surfaces of the adjacent cylinder liners, with the recesses in the adjacent cylinder liners complementing one another to form a passage.

Alternatively, the passage may be formed by a passage hollow section which is arranged and secured within the joining region. A passage hollow section of this type is first of all positioned between the cylinder liners that are to be joined to form a combination, and the liners are then joined. To join the cylinder liners, adjacent cylinder liners may in each case be secured to the passage hollow 10 section located between them, for example by means of a joining seam. Moreover, the distance between the cylinder liners along the in-line arrangement of the cylinder liners can be varied to match a predetermined center-to-center distance of the cylinder bores by means of the dimension of a passage hollow section. Alternatively, it is possible for a spacer profiled section which is arranged between the cylinder liners and is intended to maintain a definable spacing to form a passage for transporting cooling fluid. The spacer profiled section differs from the passage hollow section in that the passage is formed exclusively by the passage hollow section, whereas in the case of the spacer profile portions of the outer circumferential surfaces of the adjoining cylinder liners are also involved in forming the passage.

A cooling passage is preferably located substantially only at the level of the space, intended for the combustion of fuel, in the cylinder liners which are to be cast in as liners, in order to effect cooling of the regions which are most strongly exposed to the high temperatures. In particular, it is preferable if a passage of this type is located substantially only at the level of that end of the cylinders liners to be cast in as liners which adjoins the cylinder head gasket, so that in *particular the region adjoining the cylinder head gasket is cooled and compressive creep of the material located immediately beneath the cylinder head gasket can be prevented.

According to the invention, the cylinder liners formed from a light metal alloy with included hard phases may consist of an optionally hypereutectic aluminum-silicon alloy. The included hard phases in this alloy are formed by the silicon. Other examples of elements which are suitable for use as hard phases in the aluminum matrix may include SiC, TiO2 or Al2O3.

The silicon content in the aluminum-silicon alloy is advantageously 12-40% by weight, preferably 17-30% by weight, and particular preferably 25% by weight, in each case based on the total weight of the alloy.

The cylinder liners made from light metal alloy with included hard phases, for example from a hypereutectic aluminum-silicon, which are to be cast in as liners are advantageously produced by the spray-compacting process, which is known per se and therefore requires no further explanation at this point.

The material used for the passage hollow section forming the cooling passage is advantageously readily formable light metal alloys, for example aluminum alloys, in which there is no need for a hypereutectic content of elements which produce hard phases.

In the cylinder liner combination according to the invention, the cylinder liners advantageously have a wall thickness in the range from 3-8 mm, particularly preferably approximately 4 mm.

The combination preferably comprises 2, 3, 4, 5, 6 or 8 cylinder liners. By way of example, it is possible for a combination of 4 joined cylinder liners to be cast in as cylinder liners into the cylinder block of a four-cylinder in-line engine, or for a double combination of this type to be cast in as liners into the cylinder block of a V8 engine (2 lines of 4 cylinders). In a corresponding way, a V6 engine can be fitted with two individual combinations of in each case 3 joined cylinder liners as liners.

For accurate and simple positioning during casting into a cylinder block or a crankcase, the cylinder liner combination may advantageously be equipped with positioning or indication marks which can be applied to the combination for this purpose.

The invention further relates to a process for producing a combination of cylinder liners according to the invention as described above, in which cylinder liners which have been produced by the successive steps of spray-compacting, hot-extrusion and hot-forming, are non-positively and/or positively joined. In this case, in particular the slugs produced by spray-compacting are hot-extruded at a temperature in the range from 300-550° C. and are then processed by rotary swaging at a temperature in the range from 300-450° C.

Furthermore, the invention relates to a process for casting in a combination of cylinder liners according to the invention as described above, in which the combination is positioned in a casting mold which is used to mold the cylinder block and then light metal material is cast around it. It is preferable to use the pressure die-casting process for this purpose. The cylinder liner combination is advantageously positioned in the casting mold by means of positioning marks applied to the cylinder liner combination. If the cylinder liner combination has been provided with passages, it is advantageous if salt or sand cores which are impermeable to melt are introduced into the passages.

The invention will now be explained in more detail on the basis of exemplary embodiments and with reference to the appended drawings, in which:

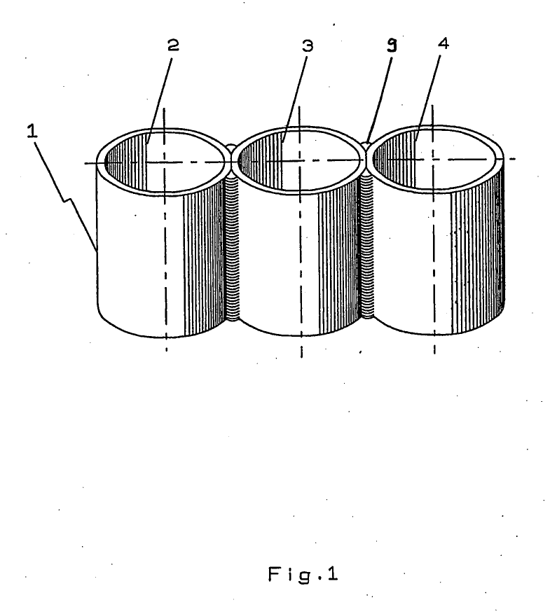

FIG. 1 shows a perspective view of a combination of cylinder liners according to the invention;

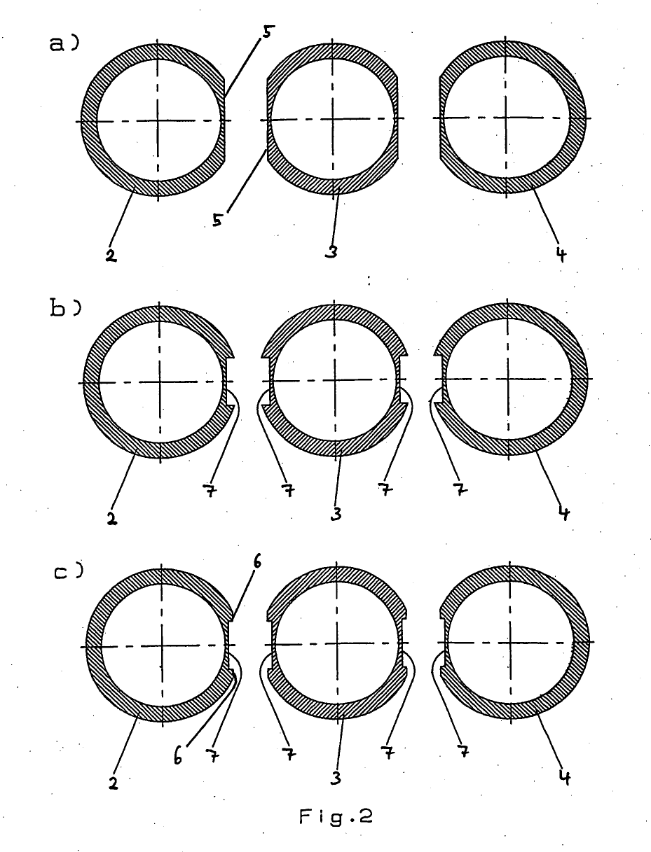

FIG. 2 shows sectional views, perpendicular to the profiled-section axis of cylinder liners, prior to joining, without cooling passages (figure a) and with cooling passages in two different designs (figures b, c);

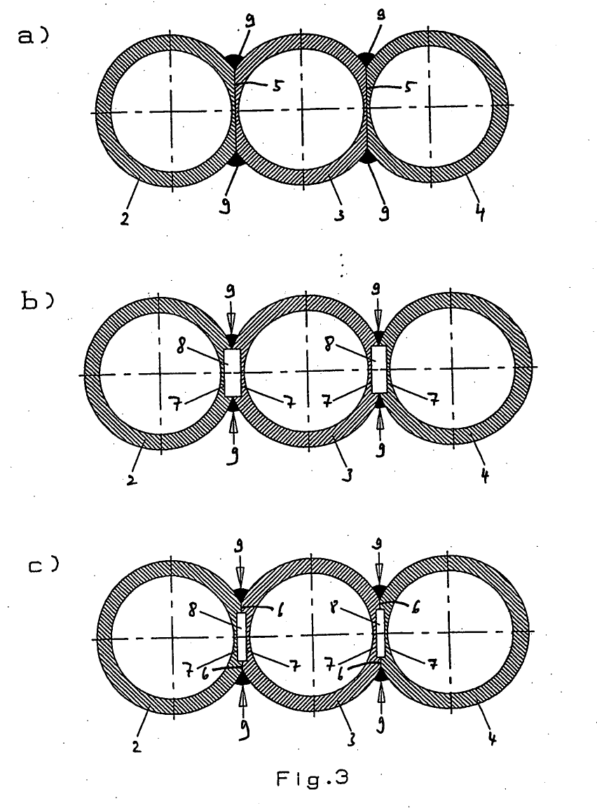

FIG. 3 shows sectional views, perpendicular to the profiled-section axis of the cylinder liners from FIG. 2, after joining, the cylinder liners having been connected by means of a joining seam;

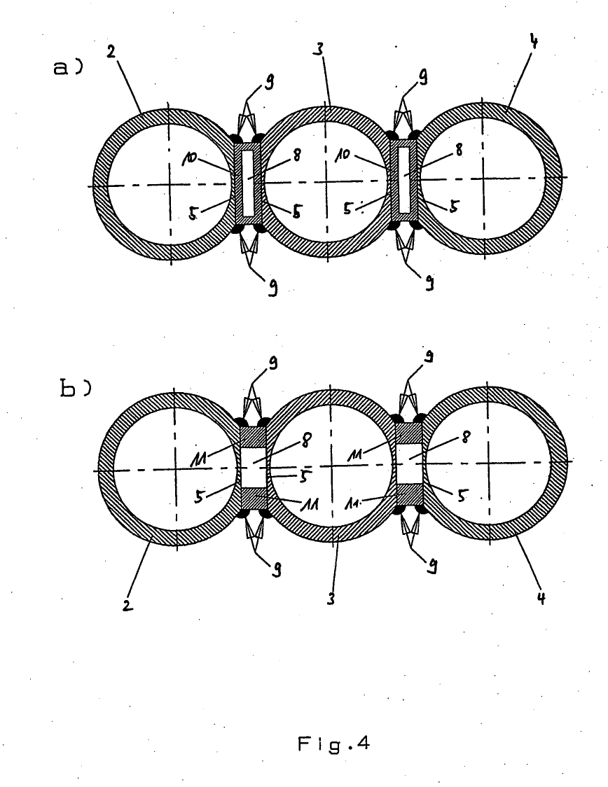

FIG. 4 shows sectional views, perpendicular to the profiled-section axis of cylinder liners, after joining, with a passage hollow section (figure a) or a spacer profiled section which forms a passage (figure b) located between two cylinder liners.

In the figures, elements which correspond to one another are denoted by identical reference numerals.

Consideration will be given first of all to FIG. 1, which illustrates a perspective view of a combination 1 according to the invention of cylinder liners for casting into the cylinder block or the crankcase of an internal combustion engine. As can be seen from FIG. 1, three cylindrical liners 2, 3, 4 are directly joined in a line at their outer circumferential surfaces to form a fixed combination, the distance between the cylinder liner axes corresponding to a predetermined center-to-center distance of the cylinder bores in a cylinder block.

The cylinder liners were produced by spray-compacting and consist of an aluminum-silicon alloy with a silicon content of 25% by weight, based on the total weight of the alloy. The wall thickness of the cylinder liners is 4 mm. The cylinder liners were joined by welding.

The combination of three cylinder liners is suitable in duplicate, for example, for casting in as liners for a V6 engine (2 lines of 3 cylinders).

FIG. 2 shows sectional views in a plane perpendicular to the profiled-section axis of different cylinder liners which are to be joined to form a combination. The upper figure a) shows cylinder liners 2, 3, 4 which have abutting surfaces in the form of flattened parts 5 in their outer circumferential surfaces. The flattened parts 5 are arranged in such a manner that they come to bear against one another when the cylinder liners are being joined. The middle figure b) shows cylinder liners 2, 3, 4 with recesses 7 formed in their outer circumferential surfaces. The recesses 7 are arranged in such a way that they form a shared cavity, specifically the passage for transporting cooling fluid, when the cylinder liners are joined. Figure c) shows a variant of the cylinder liners from figure b), in which the cylinder liners 2, 3, 4 are provided, in their outer circumferential surfaces adjoining the recesses 7, with abutting surfaces in the form of flattened parts 6 which come to bear against one another when the cylinder liners are being joined.

FIG. 3 shows sectional views, perpendicular to the profiled-section axis of the cylinder liners from FIG. 2, after joining. Figure a) shows the cylinder liners 2, 3, 4 which have been joined at their flattened parts 5. As can be seen from FIG. 3, adjacent cylinder liners are in each case connected by a joining seam 9. Figure b) shows the cylinder liners 2, 3, 4 provided with recesses 7 in the joined state. The recesses of adjacent cylinder liners in each case together form a passage 8 for transporting cooling fluid. Adjacent cylinder liners are connected by the joining seams 9. Figure c) shows the cylinder liners 2, 3, 4 which have been joined at their abutment surfaces 6. Adjacent recesses 7 in each case form a passage 8 for transporting cooling fluid. The cylinder liners have been joined by means of the joining seams 9.

The abutting surfaces 6 on the one hand cause the bearing surface of adjacent cylinder liners to be advantageously increased compared to the embodiment illustrated in figure b), and on the other hand, given a constant depth of the recesses, allow a different open space of the passages 8 to be realized with a view to a cooling capacity which is to be achieved during transporting of the cooling fluid. Furthermore, the provision of the abutment surfaces 6 makes it possible to match the distance between the cylinder liners to a smaller center-to-center distance between the cylinder bores.

FIG. 4 shows sectional views perpendicular to the profiled-section axis of the cylinder liners 2, 3, 4 after joining, with a passage hollow section 10 (figure a) or a spacer profiled section 11 (figure b) arranged between two cylinder liners. In the embodiments shown in FIG. 4, the cylinder liners are each provided with abutting surfaces in the form of flattened parts 5 which come to bear against the passage hollow sections 10 or spacer profiled sections 11 from in each case two sides. The passage hollow sections 10 or spacer profiled sections 11 are each connected to adjacent cylinder liners by the joining seams 9. Each passage hollow section 11 forms a passage 8 for transporting cooling fluid. Likewise, each spacer profiled section 11, together with adjacent portions of the outer circumferential surfaces of the cylinder liner, forms a passage 8 for transporting cooling fluid. Suitable dimensioning of the passage hollow sections 10 or spacer profiled sections 11 makes it possible to set the distance between the cylinder liner axes as a function of a predetermined center-to-center distance for the cylinder bores. It is also possible to vary the throughput within the passages with a view to a cooling capacity which is to be achieved during transportation of the cooling fluid.

Of course, the invention is not restricted to the embodiments described. In particular, the embodiments described can be combined with one another in any suitable way.

1. A combination of cylinder liners made from a light metal alloy with included hard phases for
casting into a cylinder block of an internal combustion engine, comprising:
a first cylinder liner and a second cylinder liner arranged in a linear alignment, with a center-to-center distance of the cylinder liners corresponding to a center-to-center distance of cylinder bores in the cylinder block,
wherein the first cylinder liner is joined to the second cylinder liner,
wherein at least one of the first cylinder liner and the second cylinder liner has a plane area at an outer circumferential area,
wherein the plane area is enclosed between the joined cylinder liners, and
wherein a thickness of the wall of at least one of the first cylinder liner and the second cylinder liner is reduced at the plane area.

2. The combination as claimed in claim 1 wherein the cylinder liners are joined directly.

3. The combination as claimed in claim 1 wherein the cylinder liners are joined by means of a spacer.

4. The combination as claimed in claim 1 wherein the cylinder liners are joined by means of a joining seam.

5. The combination as claimed in claim 4 wherein the joining seam is produced by a welding process selected from the group consisting of: laser welding, electron beam welding, and friction twist welding.

6. The combination as claimed in claim 1 wherein the first cylinder liner and the second cylinder liner are joined by means of a dovetail joint.

7. The combination as claimed in claim 1 wherein at least one of the first cylinder liner and the second cylinder liner is provided with a flat abutting surface at the outer circumferential surface.

8. The combination as claimed in claim 1 wherein the combination further comprises at least one passage for transporting a cooling fluid, the passage being open at at least one side, and wherein the passage is provided between the first cylinder liner and the second cylinder liner.

9. The combination as claimed in claim 8 wherein the passage is aligned parallel to a cylindrical axis of one of the first cylinder liner and the second cylinder liner.

10. The combination as claimed in claim 8 wherein the passage is formed by a recess in at least one of the outer circumferential surfaces of the at least one of the first cylinder liner and the second cylinder.

11. The combination as claimed in claim 8 wherein the passage is formed by a passage hollow section.

12. The combination as claimed in claim 8 wherein the passage is formed by a spacer profiled section.

13. The combination as claimed in one of the claim 8, characterized in that the passage is located substantially only at the level of the space of the cast-in cylinder liners which is intended for the combustion of fuel.

14. The combination as claimed in claim 8 wherein the passage is located substantially only at a level of an end of the cast-in cylinder liners, wherein the end adjoins a cylinder head gasket.

15. The combination as claimed in claim 1 wherein each the first cylinder liner and the second cylinder liner consist of an aluminum-silicon alloy.

16. The combination as claimed in claim 15 wherein the silicon content of the aluminum-silicon alloy is 12-40% by weight, based on the total weight of the alloy.

17. The combination as claimed in claim 15 wherein the silicon content of the aluminum silicon alloy is 17-30% by weight, based on the total weight of the alloy.

18. The combination as claimed in claim 15 wherein the silicon content of the aluminum silicon alloy is 25% by weight, based on the total weight of the alloy.

19. The combination as claimed in claim 1 wherein at least one of the first cylinder liner and the second cylinder liner is produced by a spray-compacting process.

20. The combination as claimed in claim 1 wherein at least one of the first cylinder liner and the second cylinder liner has a wall thickness in the range from 3-8 mm.

21. The combination as claimed in claim 20 wherein the first cylinder liner and the second cylinder liner has a wall thickness of approximately 4 mm.

22. The combination as claimed in claim 1 wherein the combination comprises a positioning mark for positioning the combination with respect the cylinder block.

23. The combination as claimed in claim 1 wherein the combination comprises an even number of cylinder liners.

24. The combination as claimed in claim 23 wherein the cylinders are s arranged in a first row and in a second row, the first row being joined to the second row.

25. The combination as claimed in claim 24 wherein the first row and the second row comprise an equal number of cylinder liners.

26. A combination of cylinder liners made from a light metal alloy with included hard phases for casting into a cylinder block of an internal combustion engine, comprising:
a first cylinder liner and a second cylinder liner arranged in a linear alignment, with a center-to-center distance of the cylinder liners corresponding to a center-to-center distance of cylinder bores in the cylinder block,
at least one passage for transporting a cooling fluid,
wherein the first cylinder liner is joined to the second cylinder liner, 20 wherein the passage is arranged between the first cylinder liner and the second cylinder liner,
wherein the passage is open at at least one side, and
wherein the passage is aligned parallel to a cylindrical axis of one of the first cylinder liner and the second cylinder liner.

27. The combination as claimed in claim 26, wherein the passage is formed by a recess in at least one of an outer circumferential surfaces of the at least one of the first cylinder liner and the second cylinder.

28. The combination as claimed in claim 26, wherein the passage is formed by a passage hollow section.

29. The combination as claimed in claim 26, wherein the passage is formed by a spacer profiled section.

30. The combination as claimed in claim 26, wherein the passage is located s substantially only at the level of the space of the cast-in cylinder liners which is intended for the combustion of fuel.

31. The combination as claimed in claim 26, wherein the passage is located substantially only at a level of an end of the cast-in cylinder liners, wherein the end adjoins a cylinder head gasket.

32. A crankcase, comprising:
a plurality of cylinder liners, the cylinder liners being made from a light metal alloy with included hard phases for casting into a cylinder block of an internal combustion engine,
wherein a first cylinder liner and a second cylinder liner are arranged in a linear alignment, with a center-to-center distance of the cylinder liners corresponding to a center-to-center distance of cylinder bores in the cylinder block,
wherein the first cylinder liner is joined to the second cylinder liner,
wherein at least one of the first cylinder liner and the second cylinder liner has a plane area at an outer circumferential area,
wherein the plane area is enclosed between the joined cylinder liners, and
wherein a thickness of the wall of at least one of the first cylinder liner and the
second cylinder liner is reduced at the plane area.

33. The crankcase as claimed in claim 32, wherein the cylinder liners are joined immediately.

34. The crankcase as claimed in claim 32, wherein the cylinder liners are joined by means of a spacer.

35. The crankcase as claimed in claim 32, wherein the cylinder liners are joined by means of a joining seam.

36. The crankcase as claimed in claim 32, wherein the first cylinder liner and the second cylinder liner are joined by means of a dovetail joint.

37. A crankcase, comprising:
a plurality of cylinder liners, the cylinder liners being made from a light metal alloy with included hard phases for casting into a cylinder block of an internal combustion engine,
at least one passage for transporting a cooling fluid,
wherein a first cylinder liner and a second cylinder liner are arranged in a linear alignment, with a center-to-center distance of the cylinder liners corresponding to a center-to-center distance of cylinder bores in the cylinder block,
wherein the first cylinder liner is joined to the second cylinder liner,
wherein the passage is arranged between the first cylinder liner and the second cylinder liner,
wherein the passage is open at at least one side, and
wherein the passage is aligned parallel to a cylindrical axis of one of the first cylinder liner and the second cylinder liner.

38. The crankcase as claimed in claim 37, wherein the passage is formed by a recess in at least one of an outer circumferential surfaces of the at least one of the first cylinder liner and the second cylinder.

39. The crankcase as claimed in claim 37, wherein the passage is formed by a passage hollow section.

40. The crankcase as claimed in claim 37, wherein the passage is formed by a spacer profiled section.
